(19) United States
(12) Patent Application Publication
(10) Pub. No.: US 2024/0139826 A1
(43) Pub. Date: May 2, 2024

(54) CEMENTED CARBIDE AND CUTTING TOOL

(71) Applicant: KYOCERA CORPORATION, Kyoto (JP)

(72) Inventors: Naohisa MATSUDA, Satsumasendai·shi, Kagoshima (JP); Shinsuke YAMAMOTO, Satsumasendai·shi, Kagoshima (JP); Takahiro HAMA, Satsumasendai·shi, Kagoshima (JP); Hideyoshi KINOSHITA, Satsumasendai·shi, Kagoshima (JP)

(21) Appl. No.: 18/548,571

(22) PCT Filed: Mar. 1, 2022
(86) PCT No.: PCT/JP2022/008482

§ 371 Date: Sep. 1, 2023

(30) Foreign Application Priority Data
Mar. 25, 2021 (JP) 2021-051057

(51) Int. Cl. B23B 27/14; C22C 29/06; C22C 29/08

(52) U.S. Cl. CPC B23B 27/148; C22C 29/067; C22C 29/08; B23B 2200/0471; B23B 2224/00; B23B 2228/10

(57) ABSTRACT

A cemented carbide includes a plurality of tungsten carbide particles, and a binder phase including Co. The binder phase further includes Cr. A region in a cross section of the cemented carbide where a distance X between surfaces of the tungsten carbide particles adjacent to each other having an opposing surface length L of 100 nm or more is 5 nm or less is a WC/WC region. A peak value of atomic percentage of Cr obtained by an elemental analysis in a transverse direction from one tungsten carbide particle to the other tungsten carbide particle in the WC/WC region is a Cr value, and a peak value of atomic percentage of Co thus obtained is a Co value. A ratio of the Cr value and the Co value (Cr value/Co value) is a Cr/Co ratio, and the Cr/Co ratio is larger than 1. A cutting tool includes the cemented carbide.

### CROSS-REFERENCE TO RELATED APPLICATION

The present application claims priority to Japanese Patent Application No. 2021-051057, filed Mar. 25, 2021. The contents of this application are incorporated herein by reference in their entirety.

### TECHNICAL FIELD

The present disclosure relates to a cemented carbide and a cutting tool.

### BACKGROUND

Cemented carbide discussed in, for example, WO 2019/138599 (Patent Document 1) has been known as cemented carbide for use in cutting tools or the like. The cemented carbide discussed in Patent Document 1 includes a hard phase composed of tungsten carbide particles, and a binder phase including Co and Cr. In a region where a distance between surfaces of tungsten carbide particles disclosed in Patent Document 1 is 5 nm or less, and a maximum value of a ratio C(R)/C(C) of a peak value C(C) of atomic percentage of Co and a peak value C(R) of atomic percentage of Cr is 0.177 presented in Sample D3 in Table 4. It is known that a solid solubility limit of Cr relative to Co is approximately 30 atm %. Patent Document 1 discloses that Co, and Cr whose amount corresponds to approximately half of the solid solubility limit are present between tungsten particles.

### SUMMARY

A cemented carbide in a non-limiting embodiment of the present disclosure includes a plurality of tungsten carbide particles, and a binder phase including at least Co. The binder phase further includes Cr. A region in a cross section of the cemented carbide where a distance X between surfaces of the tungsten carbide particles adjacent to each other having an opposing surface length L of 100 nm or more is 5 nm or less is a WC/WC region. A maximum value (atm %) of the Cr obtained by an elemental analysis in a transverse direction from one tungsten carbide particle to the other tungsten carbide particle in the WC/WC region is a Cr value, and a maximum value (atm %) of the Co thus obtained is a Co value. A ratio of the Cr value and the Co value (Cr value/Co value) is a Cr/Co ratio, and the Cr/Co ratio is larger than 1.0.

A cutting tool in a non-limiting embodiment of the present disclosure includes the cemented carbide.

### BRIEF DESCRIPTION OF THE DRAWINGS

FIG. 1 is a sectional view illustrating a cemented carbide in a non-limiting embodiment of the present disclosure;

FIG. 2 is a perspective view illustrating a cutting tool in a non-limiting embodiment of the present disclosure; and

FIG. 3 is a sectional view taken along line III-III in the cutting tool illustrated in FIG. 2.

### EMBODIMENT

<Cemented Carbide>

A cemented carbide 1 in a non-limiting embodiment of the present disclosure is described in detail below with reference to the drawings. For the convenience of description, the drawings referred to below illustrate, in simplified form, only main members necessary for describing embodiments. Hence, the cemented carbide 1 may include any arbitrary structural member not illustrated in the drawings referred to. Dimensions of the members in the drawings faithfully represent neither dimensions of actual structural members nor dimensional ratios of these members. These points are also true for a cutting tool described later.

The cemented carbide 1 may include a plurality of tungsten carbide (WC) particles. The WC particles are also called hard particles. The cemented carbide 1 may include a hard phase including the plurality of WC particles. The hard phase may include at least one kind selected from the group consisting of carbides, nitrides and carbonitrides of metals of Groups 4, 5, and 6 in the periodic table, besides WC.

A mean particle diameter of the WC particles is not limited to a specific value. For example, the mean particle diameter of the WC particles may be 0.5-3.0 μm. The mean particle diameter of the WC particles may be measured by image analysis. In that case, an equivalent circle diameter may be regarded as the mean particle diameter of the WC particles.

The cemented carbide 1 may include a binder phase including at least Co (cobalt). The binder phase may function to join adjacent WC particles. The binder phase may also function to join adjacent hard phases.

The binder phase may further include Cr (chromium). A content (mass %) of Cr included in the binder phase may be a Cr content. The Cr content may be 5 mass % or more. If the Cr content is 5 mass % or more, the cemented carbide 1 has enhanced high-temperature hardness and high-temperature strength. An upper limit value of the Cr content is not limited to a specific value. For example, the upper limit value of the Cr content may be 15 mass %. The Cr content may be measured by ICP (Inductively Coupled Plasma) analysis.

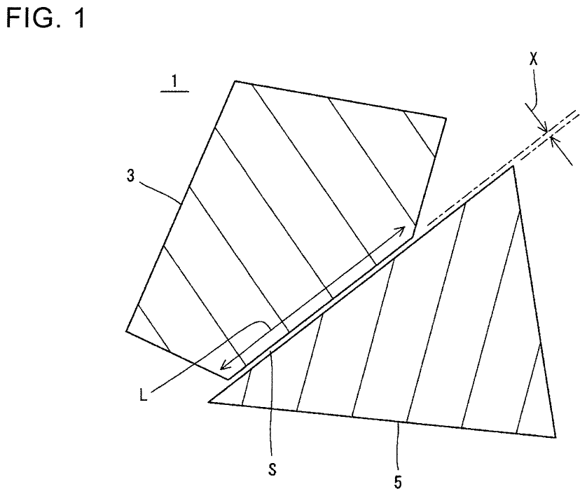

As in the non-limiting embodiment illustrated in FIG. 1, a region in a cross section of the cemented carbide 1 where a distance X between surfaces of WC particles (a first WC particle 3 and a second WC particle 5) adjacent to each other having an opposing surface length L of 10 nm or more is 5 nm or less may be a WC/WC region S.

The opposing surface length L may denote a length of surfaces that are opposite to each other in the adjacent WC particles in the cross section of the cemented carbide 1. An upper limit value of the opposing surface length L is not limited to a specific value.

A lower limit value of the distance X is not limited to a specific value. For example, the lower limit value of the distance X may be 0 nm. That is, at least a part of the adjacent WC particles may be in contact with each other in the WC/WC region S. The distance X may be constant over an entire length of the WC/WC region. The term “constant” may be approximately constant, and need not be strictly constant.

An elemental analysis of the WC/WC region S may be conducted in a transverse direction from one WC particle (the first WC particle 3) to the other WC particle (the second WC particle 5). The elemental analysis may be carried out by, for example, Energy-dispersive X-ray Spectroscopy (EDS).

A maximum value (atm %) of Cr may be a Cr value, and a maximum value (atm %) of Co may be a Co value, both of which are obtained by the elemental analysis. A ratio of the Cr value and the Co value (Cr value/Co value) may be a Cr/Co ratio.

The Cr/Co ratio may be larger than 1.0. In this case, strength deterioration at high temperatures is less significant. Specifically, if there is more Cr than Co in the WC/WC region S, it is estimated that the WC/WC region S has enhanced high-temperature characteristics in terms of hardness and strength, thereby avoiding the strength deterioration at high temperatures of the cemented carbide 1. It is therefore easy to avoid propagation of cracks due to impact at high temperatures.

In the cemented carbide 1, Cr dissolved in the binder phase segregates or precipitates in the WC/WC region S in a cooling process, and there is relatively more Cr than Co in the WC/WC region. Consequently, it is presumed that the strength deterioration can be avoided even at high temperatures because of high adhesion strength between WC particles opposed to each other with the WC/WC region S interposed therebetween. Because a rate of Cr to Co in the WC/WC region S exceeds a solid solubility limit, there is probability that Cr is present in the form of carbide or the like.

As used here, the high temperatures may denote 600-1000° C. For example, a cross-sectional observation using EDS included in an electron microscope may be carried out to confirm as to whether there is relatively more Cr than Co in the WC/WC region S. Examples of the electron microscope may include Scanning Electron Microscope (SEM) and Transmission Electron Microscope (TEM).

The Cr/Co ratio may be 1.2 or more. In this case, it is estimated that the high-temperature characteristics, such as hardness and strength, of the WC/WC region S have been further enhanced, and the strength deterioration of the cemented carbide 1 at high temperatures can be further avoided. An upper limit value of the Cr/Co ratio is not limited to a specific value. For example, the upper limit value of the Cr/Co ratio may be 2.5.

The Cr value may be 4 atm % or more. In this case, the strength deterioration of the cemented carbide 1 at high temperatures can be avoided, and it is easy to avoid propagation of cracks due to impact at high temperatures. An upper limit value of the Cr value is not limited to a specific value. For example, the upper limit value of the Cr value may be 8 atm %.

The Co value may be 1-10 atm %.

The binder phase may include Co at a rate of 85-92 mass % in the binder phase. This achieves a good balance between high-temperature strength and high-temperature hardness of the cemented carbide 1, and the cemented carbide 1 is suitable for difficult-to-machine material machining and high-speed machining. A content (mass %) of Co included in the binder phase may be a Co content. The Co content may be measured in the same manner as the Cr content.

The binder phase may further include W (tungsten). A content (mass %) of W included in the binder phase may be a W content. As described above, the content (mass %) of Cr included in the binder phase may be a Cr content. A ratio of Cr content and W content (Cr content/W content) may be 1.2-2.0.

If a mass ratio of Cr and W (Cr content/W content) included in the binder phase is 1.2-2.0, the binder phase has a low melting point. This leads to improved sinterability, and it is easy to improve room temperature strength of the cemented carbide. The ratio of Cr content and W content (Cr content/W content) may be 1.40-1.85. The W content may be 3.0-5.0 mass %. The W content may be measured in the same manner as the Cr content.

The cemented carbide 1 may have a thermal conductivity of 70 W/m·K or more. If the cemented carbide 1 is used as a cutting tool, it is easy to mitigate the influence of thermal impact due to a sharp temperature change during machining. Especially, mechanical property deterioration due to a significant temperature change in a tool cutting edge can be avoided, thus leading to excellent machining performance in high-speed and high-efficiency machining.

An upper limit value of thermal conductivity is not limited to a specific value. For example, the upper limit value of thermal conductivity may be 90 W/m·K. The thermal conductivity may be measured by laser flash method. Measuring conditions may be based on JIS R1611 2010.

<Method for Manufacturing Cemented Carbide>

A method for manufacturing the cemented carbide in a non-limiting embodiment of the present disclosure is described below by exemplifying the case of manufacturing the cemented carbide 1.

Firstly, WC powder, Co powder, and Cr₃C₂ powder may be prepared as raw material powder. For example, proportions and mean particle diameters of the raw material powders may be set as follows. The proportion of the WC powder may be 86-95 mass %. The proportion of the Co powder may be 5-11 mass %. The proportion of the Cr₃C₂ powder may be 0.4-1.5 mass %.

The mean particle diameter of the WC powder may be 0.4-3.0 μm. The mean particle diameter of the Co powder may be 0.5-3.0 μm. The mean particle diameter of the Cr₃C₂ powder may be 0.5-3.5 μm. The mean particle diameter of the raw material powders may be values measured by micro-track method.

A molded body may be obtained by mixing the prepared raw material powders, followed by molding. Examples of molding method may include press molding, cast molding, extrusion molding and cold isostatic press molding.

The obtained molded body may be subjected to debinding treatment, followed by sintering. The sintering may be carried out in a vacuum of 0.5-100 Pa. A sintering temperature may be 1350-1550° C. Sintering time may be 30-180 minutes.

The cemented carbide 1 may be obtained by cooling after sintering. In general, the cooling is often started directly by turning off a heater from a state where a high temperature is kept in a vacuum. However, the Cr/Co ratio does not exceed 1.0 under this colling conditions. In manufacturing the cemented carbide 1, after keeping at a maximum temperature in the sintering, the cooling may be carried out by controlling a cooling speed at 5-30° C./min. Keeping at the maximum temperature is also called a primary keeping. A secondary keeping of keeping 0.5-3 hours in a temperature range of 1150-1350° C. may be set at the stage of the cooling. Further, a mixed gas of N₂ gas, Ne gas, He gas, and Ar gas may be introduced between the primary keeping and the secondary keeping. At the point in time when temperature has dropped to a secondary keeping temperature, deaeration may be carried out again, and pressure may be set to 100 Pa or less.

In general, the cooling is often carried out in a state where a gas atmosphere (native atmosphere) generated from the molded body during the sintering remains. In manufacturing the cemented carbide 1, the mixed gas of N₂ gas, Ne gas, He gas, and Ar gas may be introduced, and deaeration may be carried out again, and pressure may be set to 100 Pa or less so as to avoid the native atmosphere during the cooling. Consequently, the native atmosphere containing much CO gas tends to become uniform and thinner in a furnace. It is assumed that this avoids a native gas influence (CO gas influence) on the cemented carbide 1, and a C concentration in the binder phase of the cemented carbide 1 decreases to facilitate an increase in W content and Cr content in the binder phase.

The Cr content in the WC/WC region S tends to increase by adjusting solid-liquid coexisting time of the binder phase in control of the cooling speed, the secondary keeping temperature/time, and the native atmosphere. In cases where the secondary keeping temperature during the cooling is set to not lower than 10° C., which is a lower limit value of liquid phase temperature of the binder phase, and not higher than 100° C., it is easy to adjust the ratio of the Cr content and the W content (Cr content/W content) in the binder phase to 1.2-2.0. The thermal conductivity of the cemented carbide 1 tends to become 70 W/m·K or more by adjusting the particle diameter of WC powder used. If WC powder having a mean particle diameter of 0.45 μm is used as a raw material, a particle diameter of WC particles of an obtained sintered body is 0.8 μm or less under the above-mentioned sintering conditions, and it is difficult to obtain the thermal conductivity of 70 W/m·K or more. The raw material of WC powder used may have a mean particle diameter of 1 μm or more.

The above manufacturing method is an embodiment of the method for manufacturing the cemented carbide 1. Therefore, it is to be noted that the cemented carbide 1 is not limited to those manufactured by the above manufacturing method.

<Cutting Tool>

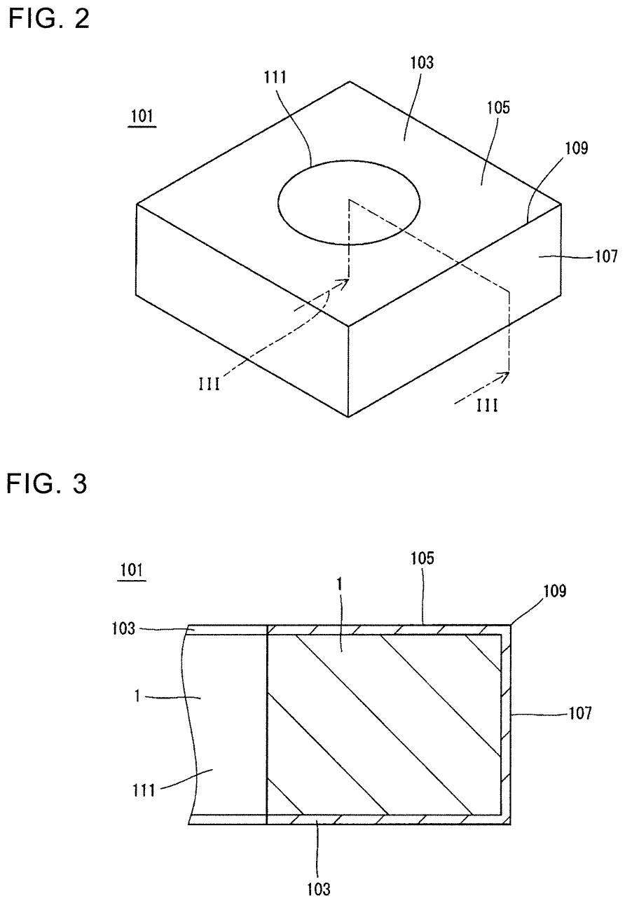

A cutting tool 101 in a non-limiting embodiment of the present disclosure is described below with reference to FIGS. 2 and 3.

The cutting tool 101 may include the cemented carbide 1. In this case, a stable machining process can be carried out over a long term because the cemented carbide 1 is less susceptible to strength deterioration at high temperatures. The cutting tool 101 may include the cemented carbide 1 as a base.

The cutting tool 101 may include a coating film 103 to cover at least a part of the surface of the cemented carbide 1. This may lead to high wear resistance of the cutting tool 101. The coating film 103 may be deposited by, for example, chemical vapor deposition (CVD) method or physical vapor deposition (PVD) method. The coating film 103 may be made of a single layer or a plurality of laminated layers. Examples of composition of the coating film 103 may include titanium carbide (TiC), titanium nitride (TiN), titanium carbonitride (TiCN), titanium carbonitride oxide (TiCNO) and alumina (Al₂O₃).

The coating film 103 is not limited to one having a specific thickness. The thickness of the coating film 103 may be set to, for example, approximately 1-30 μm. The thickness of the coating film 103 may be measured by cross-sectional observation using an electron microscope.

FIGS. 2 and 3 illustrate a cutting insert as a non-limiting embodiment of the cutting tool 101. The cutting tool 101 is not limited to the cutting insert.

The cutting tool 101 may include a first surface 105 (upper surface), a second surface 107 (lateral surface) adjacent to the first surface 105, and a cutting edge 109 located on at least a part of a ridgeline part of the first surface 105 and the second surface 107.

The first surface 105 may be a rake surface. The whole or a part of the first surface 105 may be the rake surface. For example, a region along the cutting edge 109 in the first surface 105 may be the rake surface.

The second surface 107 may be a flank surface. The whole or a part of the second surface 107 may be the flank surface. For example, a region along the cutting edge 109 in the second surface 107 may be the flank surface.

The cutting edge 109 may be located on a part or the whole of the ridgeline part. The cutting edge 109 is usable for machining a workpiece.

The cutting tool 101 may include a through hole 111. The through hole 111 is usable for attaching a fixing screw or clamping member when fixing the cutting tool 101 to a holder. The through hole 111 may be formed from the first surface 105 to the surface (lower surface) located on a side opposite to the first surface 105.

Alternatively, the through hole 111 may open into these surfaces. There is no problem even if the through hole 111 is configured to open into regions opposed to each other in the second surface 107.

The cutting tool 101 may have a quadrangular plate shape. The shape of the cutting tool 101 is not limited to the quadrangular plate shape. For example, the first surface 105 may have a triangular shape, a pentagonal shape, a hexagonal shape, or a circular shape. The cutting tool 101 may have a columnar shape.

The cutting tool 101 is not limited to a specific size. For example, a length of one side of the first surface 105 may be set to approximately 3-20 mm. A height from the first surface 105 to the surface (lower surface) located on the side opposite to the first surface 105 may be set to approximately 5-20 mm.

Although the cemented carbide 1 and the cutting tool 101 in the non-limiting embodiments of the present disclosure have been exemplified above, it is to be noted that the present disclosure is not limited to the above embodiments, but may have any embodiment without departing from the scope of the present disclosure.

For example, even though the above non-limiting embodiments have illustrated and described the case of applying the cemented carbide 1 to the cutting tool 101, the cemented carbide 1 is applicable to other uses. Examples of other uses may include wear-resistant components such as sliding components and metal molds, digging tools, tools such as edged tools, and impact-resistant components.

Although the present disclosure is described in detail below by giving Examples, the present disclosure is not limited to the following Examples.

### Examples

[Samples Nos. 1 to 23]

<Manufacturing of Cemented Carbide>

Firstly, raw material powders presented in columns of blended compositions in Table 1 were prepared. Mean particle diameters of the raw material powders were values measured by micro-track method. Mixed raw material powders were individually obtained by mixing the prepared raw material powders in combinations and proportions presented in Table 1.

Subsequently, the mixed raw material powder was press-molded into a cutting tool shape (CNMG120408 PNMU1205), thereby obtaining a molded body. The obtained molded body was subjected to debinding treatment and kept in a vacuum of 0.5-100 Pa at 1400° C. for one hour.

This was cooled after being kept at 1400° C. under cooling conditions presented in columns of cooling process in Table 1 while controlling a native atmosphere, thereby obtaining a cemented carbide (base). A side of a rake surface (first surface) of the obtained cemented carbide was subjected to edge treatment (round honing) by brushing.

TABLE 1

| | Blended composition | | | | | | | | | Cooling process | | |
|---|---|---|---|---|---|---|---|---|---|---|---|---|
| | WC | | Co | | Cr₃C₂ | | Vacuum | | | | Secondry | |
| | Mean | | Mean | | Mean | | sintering | Primary | | | keeping | Secondry |
| Sam- | particle | | particle | | particle | | temper- | keeping | Native | Cooling | temper- | keeping |
| ple | diameter | | diameter | | diameter | | ature | time | atomosphere | speed | ature | time |
| No. | (μm) | (mass %) | (μm) | (mass %) | (μm) | (mass %) | (° C.) | (h) | control | (° C./min) | (° C.) | (h) |
| 1 | 2.5 | 91.0 | 2.7 | 8 | 2.9 | 1.0 | 1400 | 1 | with | 5 | 1250 | 1 |
| 2 | 2.5 | 91.0 | 2.7 | 8 | 2.9 | 1.0 | 1400 | 1 | with | 10 | 1250 | 1 |
| 3 | 2.5 | 91.0 | 2.7 | 8 | 2.9 | 1.0 | 1400 | 1 | with | 15 | 1250 | 1 |
| 4 | 2.5 | 91.0 | 2.7 | 8 | 2.9 | 1.0 | 1400 | 1 | with | 20 | 1250 | 1 |
| 5 | 2.5 | 91.0 | 2.7 | 8 | 2.9 | 1.0 | 1400 | 1 | with | 30 | 1250 | 1 |
| 6 | 2.5 | 91.0 | 2.7 | 8 | 2.9 | 1.0 | 1400 | 1 | with | 40 | 1250 | 1 |
| 7 | 2.5 | 91.0 | 2.7 | 8 | 2.9 | 1.0 | 1400 | 1 | with | 15 | 1150 | 1 |
| 8 | 2.5 | 91.0 | 2.7 | 8 | 2.9 | 1.0 | 1400 | 1 | with | 15 | 1200 | 1 |
| 9 | 2.5 | 91.0 | 2.7 | 8 | 2.9 | 1.0 | 1400 | 1 | with | 15 | 1300 | 1 |
| 10 | 2.5 | 91.0 | 2.7 | 8 | 2.9 | 1.0 | 1400 | 1 | with | 15 | 1350 | 1 |
| 11 | 2.5 | 91.0 | 2.7 | 8 | 2.9 | 1.0 | 1400 | 1 | with | 15 | 1250 | 0.5 |
| 12 | 2.5 | 91.0 | 2.7 | 8 | 2.9 | 1.0 | 1400 | 1 | with | 15 | 1250 | 2 |
| 13 | 2.5 | 91.0 | 2.7 | 8 | 2.9 | 1.0 | 1400 | 1 | with | 15 | 1250 | 3 |
| 14 | 0.5 | 91.0 | 2.7 | 8 | 2.9 | 1.0 | 1400 | 1 | with | 20 | 1200 | 1 |
| 15 | 1.0 | 91.6 | 2.7 | 8 | 2.9 | 0.4 | 1400 | 1 | with | 5 | 1300 | 1 |
| 16 | 1.0 | 91.6 | 2.7 | 8 | 2.9 | 0.4 | 1400 | 1 | with | 10 | 1200 | 1 |
| 17 | 0.7 | 93.1 | 2.7 | 6 | 2.9 | 0.9 | 1400 | 1 | with | 15 | 1250 | 1 |
| 18 | 0.7 | 93.1 | 2.7 | 6 | 2.9 | 0.9 | 1400 | 1 | with | 30 | 1350 | 1 |
| 19 | 0.7 | 89.1 | 2.7 | 10 | 2.9 | 0.9 | 1400 | 1 | with | 15 | 1250 | 1 |
| 20 | 2.5 | 91.0 | 2.7 | 8 | 2.9 | 1.0 | 1400 | 1 | without | 5 | None | — |
| 21 | 2.5 | 91.0 | 2.7 | 8 | 2.9 | 1.0 | 1400 | 1 | without | 15 | None | — |
| 22 | 2.5 | 91.0 | 2.7 | 8 | 2.9 | 1.0 | 1400 | 1 | without | 40 | None | — |
| 23 | 2.5 | 92.0 | 2.7 | 8 | 2.9 | 0.0 | 1400 | 1 | with | 20 | 1250 | 1 |

<Evaluation>

A mean particle diameter of WC particles, contents, an elemental analysis and thermal conductivity were measured in each of the obtained cemented carbides. A machining evaluation was conducted to evaluate fracture resistance. Measuring systems are as follows, and results are presented in Table 2.

(Means Particle Diameter of WC Particles)

The mean particle diameter of the WC particles was measured in the following manner. Firstly, a cross section of WC-based cemented carbide was observed at 3000-5000× magnification with a Scanning Electron Microscope (SEM), thereby obtaining an SEM image. At least 50 pieces or more, preferably 100 pieces or more of the WC particles in the SEM image were identified and extracted. Thereafter, the mean particle diameter of the WC particles was obtained by calculating an equivalent circle diameter with the use of image analysis software ImageJ (1.52).

(Contents)

Contents of individual metal elements (Cr content, Co content and W content) relative to a sum of the metal elements were calculated by conducting a composition analysis of the metal elements in the binder phase included in the cemented carbide by ICP analysis. A ratio (Cr content/W content) was calculated using the Cr content and the W content. The ICP analysis was conducted in the following manner. Firstly, the cemented carbide was pulverized. Then, 0.2 g of pulverized cemented carbide powder was weighed. This was subjected to acid dissolution using an aqueous solution obtained by adding 1 HCl for 1 water on a volume basis. The acid dissolution was conducted by stirring the aqueous solution by a stirrer for 24 hours while keeping the aqueous solution at 70° C. Thereafter, the ICP analysis was conducted using a filtered aqueous solution. An ICP optical emission spectrometer PQ9000Elite (manufactured by Analytik Jena) was used as a measuring system.

(Elementary Analysis)

A region in the cross section of the cemented carbide where a distance X between surfaces of WC particles adjacent to each other having an opposing surface length L of 100 nm or more was 5 nm or less was a WC/WC region.

The WC/WC region was subjected to elementary analysis in a transverse direction from one WC particle to the other WC particle, thereby obtaining a Cr value and a Co value. A Cr/Co ratio was calculated using the Cr value and the Co value thus obtained. Other three or more WC/WC regions were also subjected to the elemental analysis in the same manner. An average value of each of obtained Cr values, Co values and Cr/Co ratios was obtained. Examples of measuring systems and measuring conditions used in TEM and TEM-EDS analysis are described below.

Systems:
FIB: Focused Ion Beam Processing and Observation system JIB-4700F (manufactured by JEOL Ltd.)
TEM: Transmission/Scanning Electoron Microscope JEM-ARM200F (manufactured by JEOL Ltd.)
EDS: Energy Dispersive X-ray Spectrometer JED-2300T (manufactured by JEOL Ltd.)

Conditions:
FIB processing: Acceleration voltage: 30, 3 kV Deposition film: C, Sample pretreatment C vapor deposition
TEM Analysis: Acceleration voltage: 200 kV
EDS Analysis: Acceleration voltage: 200 kV, Illumination current dose: approximately 68 pA, Measuring time: 30 sec/point

(Thermal Conductivity)

Measurement was made with laser flash method by using Model Number LFA-502 manufactured by KYOTO ELECTRONICS MANUFACTURING CO., LTD. Measuring conditions were based on JIS R1611 2010.

(Machining Evaluation)

Machining performance test was conducted under the following conditions.

(1) Fracture Resistance Test
Workpiece: Heat-resistant cast steel SCH12 square bar
Tool Shape: PNMU1205ANER-GM
Cutting Speed: 150 m/min
Feed: 0.30 mm/rev
Depth of Cut: ap=2.0 mm ae=50 mm
Coolant: Dry
Evaluation Item: Measuring machining time (machining life) until a tool maximum fracture width is 0.2 mm or more

(2) Wear Resistance Test
Workpiece: Heat-resistant cast steel SCH12 square bar
Tool Shape: PNMU1205ANER-GM
Cutting Speed: 200 m/min
Feed: 0.20 mm/rev
Depth of Cut: ap=2.0 mm ae=50 mm
Coolant: Dry
Evaluation Item: Measuring machining time (machining life) until a tool maximum fracture width is 0.2 mm or more

TABLE 2

| | | | | | | | | Mean particle | | |
|---|---|---|---|---|---|---|---|---|---|---|
| | WC/WC region | | Binder phase composition | | | | | diameter | Fracture | Wear |
| | | Cr | Co | Cr | W | Cr | Thermal | of WC | resistance | resistance |
| Sample | Cr/Co | value | content | content | content | content/ | conductivity | particles | test | test |
| No. | ratio | (atm %) | (mass %) | (mass %) | (mass %) | W content | (W/m · K) | (μm) | (min) | (min) |
| 1 | 1.9 | 5.9 | 89.7 | 5.5 | 4.8 | 1.15 | 76 | 1.2 | 11.5 | 2.5 |
| 2 | 1.7 | 5.2 | 88.9 | 6.5 | 4.6 | 1.41 | 78 | 1.23 | 12.4 | 3.7 |
| 3 | 1.3 | 4.5 | 88.2 | 7.4 | 4.4 | 1.68 | 80 | 1.25 | 15.4 | 4.8 |
| 4 | 1.2 | 4.2 | 88.1 | 7.7 | 4.2 | 1.83 | 75 | 1.13 | 12.3 | 3.7 |
| 5 | 1.1 | 3.9 | 88.0 | 8.1 | 3.9 | 2.08 | 76 | 1.14 | 12.8 | 2.4 |
| 6 | 1.0 | 3.2 | 87.9 | 8.4 | 3.7 | 2.27 | 73 | 1.1 | 8.8 | 1.9 |
| 7 | 1.5 | 4.9 | 88.7 | 6.5 | 4.8 | 1.35 | 74 | 1.11 | 13.5 | 2.9 |
| 8 | 1.4 | 4.7 | 88.4 | 7.0 | 4.6 | 1.52 | 77 | 1.28 | 14.9 | 3.6 |
| 9 | 1.2 | 4.3 | 88.1 | 7.6 | 4.3 | 1.77 | 83 | 1.34 | 14.2 | 4.7 |
| 10 | 1.1 | 4.1 | 88.0 | 8.1 | 3.9 | 2.08 | 74 | 1.19 | 12.9 | 2.4 |
| 11 | 1.1 | 4.2 | 88.3 | 7.5 | 4.2 | 1.79 | 81 | 1.28 | 11.1 | 2.8 |
| 12 | 1.4 | 4.9 | 88.2 | 7.2 | 4.6 | 1.57 | 81 | 1.28 | 12.7 | 4.6 |
| 13 | 1.5 | 5.2 | 88.2 | 7.0 | 4.8 | 1.46 | 79 | 1.27 | 12.8 | 4.4 |
| 14 | 1.2 | 4.1 | 88.0 | 7.4 | 4.6 | 1.61 | 63 | 0.73 | 11.5 | 3.1 |
| 15 | 1.1 | 4.1 | 91.9 | 4.0 | 4.1 | 0.98 | 72 | 1.09 | 11.9 | 2.2 |
| 16 | 1.1 | 4.0 | 92.4 | 3.7 | 3.9 | 0.95 | 71 | 1.05 | 10.1 | 2.3 |
| 17 | 1.2 | 4.4 | 85.3 | 9.4 | 5.3 | 1.77 | 65 | 0.8 | 10.5 | 2.8 |
| 18 | 1.1 | 4.2 | 84.7 | 10.2 | 5.1 | 2.00 | 68 | 0.89 | 9.8 | 2.5 |
| 19 | 1.1 | 4.1 | 90.3 | 6.5 | 3.2 | 2.03 | 65 | 0.8 | 11.7 | 2.6 |
| 20 | 0.9 | 2.9 | 92.0 | 4.8 | 3.2 | 1.50 | 75 | 1.2 | 7.2 | 0.9 |
| 21 | 0.8 | 2.8 | 92.3 | 5.2 | 2.5 | 2.08 | 74 | 1.18 | 6.9 | 1.2 |
| 22 | 0.7 | 2.5 | 92.8 | 6.7 | 0.5 | 13.40 | 82 | 1.3 | 7.9 | 1.1 |
| 23 | — | — | 94.8 | 0.0 | 5.2 | 0.00 | 82 | 1.43 | 5.7 | 0.9 |

All of Samples Nos. 1 to 5 and Nos. 7 to 19, which are the cemented carbides of the present disclosure, were excellent in fracture resistance and wear resistance.

### DESCRIPTION OF THE REFERENCE NUMERAL

1 cemented carbide
3 first tungsten carbide particle
5 second tungsten carbide particle
101 cutting tool
103 coating film
105 first surface
107 second surface
109 cutting edge
111 through hole
L opposing surface length
X distance
S WC/WC region

1. A cemented carbide, comprising a plurality of tungsten carbide particles, and a binder phase comprising at least Co, wherein
the binder phase further comprises Cr,
a region in a cross section of the cemented carbide where a distance X between surfaces of the tungsten carbide particles adjacent to each other having an opposing surface length L of 100 nm or more is 5 nm or less is a WC/WC region,
a maximum value (atm %) of the Cr obtained by an elemental analysis in a transverse direction from one tungsten carbide particle to another tungsten carbide particle in the WC/WC region is a Cr value, a maximum value (atm %) of the Co thus obtained is a Co value, and a ratio of the Cr value and the Co value (Cr value/Co value) is a Cr/Co ratio, and
the Cr/Co ratio is larger than 1.0.

2. The cemented carbide according to claim 1, wherein the Cr/Co ratio is 1.2 or more.

3. The cemented carbide according to claim 1, wherein the Cr value is 4 atm % or more.

4. The cemented carbide according to claim 1, wherein the binder phase comprises the Co at a rate of 85-92 mass %.

5. The cemented carbide according to claim 1, wherein the binder phase comprises the Cr at a rate of 5 mass % or more.

6. The cemented carbide according to claim 1, wherein the binder phase further comprises W, wherein
a content (mass %) of W in the binder phase is a W content, and a content (mass %) of Cr in the binder phase is a Cr content, and
a ratio of the Cr content and the W content (Cr content/W content) is 1.2-2.0.

7. The cemented carbide according to claim 1, wherein the cemented carbide has a thermal conductivity of 70 W/m·K or more.

8. A cutting tool, comprising the cemented carbide according to claim 1.

9. The cutting tool according to claim 8, comprising a coating film to cover at least a part of a surface of the cemented carbide.
